(19) United States
(12) Patent Application Publication
(10) Pub. No.: US 2004/0064251 A1
(43) Pub. Date: Apr. 1, 2004

(54) Telematics system with vehicle network

(76) Inventors: Ronald Hugh Miller, Saline, MI (US); Irving Toivo Salmeen, Ann Arbor, MI (US)

Correspondence Address: KEVIN G. MIERZWA, ARTZ & ARTZ, P.C., 28333 TELEGRAPH ROAD, SUITE 250, SOUTHFIELD, MI, 48034, US

(21) Appl. No.: 10/065,305

(22) Filed: Oct. 1, 2002

(51) Int. Cl. G01S 1/00

(52) U.S. Cl. 701/213; 701/1; 342/357.06

(57) ABSTRACT

A communication system is provided in which a vehicle network (12) communicates with a telematics system (14) through a communication network (15). The telematics system generates location-specific information from the location of the network. The vehicle network shares the location-specific information to provide efficiencies in the telematics system communicating with various vehicles.

### BACKGROUND OF INVENTION

1. Technical Field

The present invention relates generally to vehicle-to-vehicle communication systems, and more particularly, to a vehicle communication system that has telematics capabilities.

2. Background

Telematics systems are currently employed in automotive vehicles. Telematics systems provide information to individual vehicles at the vehicle operator″s request. For example, concierge-type services are provided through a vehicle communication system that is commonly coupled to a satellite. Upon the push of a button, an operator in a central location may provide information to the vehicle operator as to upcoming service stations, restaurants, and other information. Currently, such systems are manual in that the vehicle operator must first initiate communication with a central location. Such information is personnel intensive because many vehicles in the same area may be requesting similar information and therefore enough telematics operators must be provided so that timely information may be provided to each of the vehicle operators.

It would therefore be desirable to provide a system whereby telematics information may be distributed more efficiently and thus less costly than previously known information.

### SUMMARY OF INVENTION

The present invention provides a vehicle positioned within a vehicle network that has a plurality of vehicles. The vehicle network generates locations of specific information and communicates the location of specific information to the vehicle network.

In a further aspect of the invention, a method of operating a communication network comprises generating communication signals among a plurality of vehicles to form a wireless network therebetween; communicating location information from the wireless network to a telematics provider; transmitting location-specific information from the telematics provide to said wireless network; and distributing the location specific information among the plurality of vehicles.

One advantage of the invention is that location-specific information is more quickly provided to vehicles within the vehicle network. That is, less repetition is required by the telematics service provider and the cost of providing such information is reduced.

Other advantages and features of the present invention will become apparent when viewed in light of the detailed description of the preferred embodiment when taken in conjunction with the attached drawings and appended claims.

### BRIEF DESCRIPTION OF DRAWINGS

FIG. 1 is a schematic view of a vehicle network coupled to a telematics system according to the present invention.

FIG. 2 is a block diagrammatic-schematic view of a typical automotive vehicle of FIG. 1.

### DETAILED DESCRIPTION

In the following figures the same reference numeral will be used to identify the same components. In the following description, various specific examples of information communicated to and from the network are provided. However, the specific information is provided by example only and is not meant to be limiting.

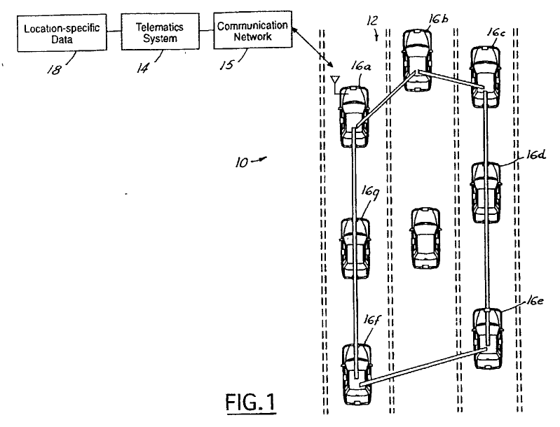

Referring now to FIG. 1, a communication system 10 includes a vehicle network 12 and a telematics system 14 that are coupled together through a communication network 15.

Vehicle network 12 includes a plurality of vehicles 16A, 16B, 16C, 16D, 16E, 16F, and 16G. Vehicles 16A-16G are similarly configured in terms of network access and network capabilities. A typical configuration for a vehicle will be further described below. The vehicle network 12 may be referred to as a floating network. The floating network is dynamic and changes as the vehicles move. That is, based upon the position information provided to the network, a certain grouping of vehicles forms the network. As vehicles move in their various directions, vehicles will be added and removed from the network based upon their positions. The vehicles need not be immediately adjacent to each other to form a network. That is, a vehicle network may extend for yards, hundreds of yards, or within a few miles depending on the geographic location and the amount of information to be provided to the vehicles within the geographic location.

Telematics system 14 is used to obtain various types of information and provide that information through communication network 15 to the vehicle network. One example of types of data is location-specific data 18 that is illustrated as a separate box. The location-specific data may be generated by telematics system 14 or may be provided in a database. That is, based upon the information of vehicle network 12, specific information may be provided to the vehicle network 12 such as road conditions, restaurants, service stations, or the like. The general motion of vehicle network 12 is also taken into consideration so that such information may be provided prior to the vehicle network reaching the particular destinations. The telematics system 14 may be manually operated or automatically operated. Preferably, a combination of both is used. That is, general location-specific data may be provided to vehicle network. If specific information is requested by one of the vehicles within the vehicle network, this information may be provided to the entire vehicle network. The information provided by telematics system 14 is provided to the vehicle operator so that the vehicle operator may use such information in a useful manner.

Communication network 15 may include various types of communication networks including a satellite, a cellular phone network, or combinations thereof. The communication network 15 may be public or private.

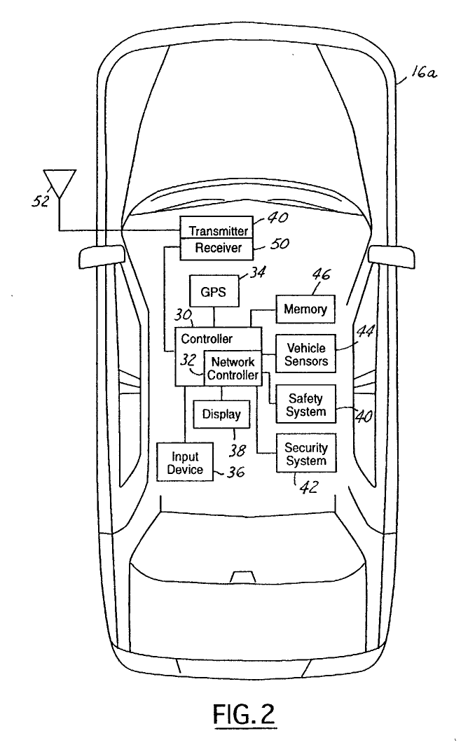

Referring now to FIG. 2, vehicle 16A is illustrated as a typical vehicle within vehicle network above. Vehicle 16A has a controller 30 that controls various functions of the vehicle and may include a network controller function illustrated as block 32. Controller 30 is coupled to a global positioning system 34 that provides the vehicle location to controller 30. Controller 30 may also include an input device 36 and a display 38. Input device 36 may, for example, be a keyboard, voice activation, touch pad, or other type of device to provide information to controller 30. A display 38 provides various information to the vehicle operator. Display 38 may be audible or visual. Preferably, display 38 is visual and may be used for displaying location-specific data.

Controller 30 may be used to control or may be coupled to a safety system 40 and a security system 42. Safety system 40 and security system 42 may interact with the vehicle network so that specific information such as vehicle theft may be provided to the vehicle network.

Controller 30 may also act with other vehicle sensors to be used in communication with the other vehicles. Specific examples of vehicle data that may be provided from vehicle sensors 44 include speed and heading. Other information such as tire wear and brake wear may also be provided.

Controller 30 includes a memory 46 that is used to store various information for retrieval. Memory 46 may, for example, be RAM, ROM, or other types of memory.

Controller 30 is also coupled to a transmitter 48 and receiver 50. Transmitter 48 and receiver 50, although illustrated as separate components, may be combined in a single transceiver or transponder. The transmitter 48 and receiver 50 are coupled to an antenna 52.

In operation, network controller 32 is used to establish and maintain the vehicle network 12. The vehicle network 12 may be established by communicating with various vehicles. The size of the vehicle network may be changed based upon the location. As the vehicle network moves, vehicles are added and removed from the vehicle network based upon their proximity to the other vehicles. One of the vehicles acts as a link to communication network 15. Although, more than one vehicle may provide information to communication network 15. The telematics system 14 receives the location information from the wireless communication network 15. Location-specific data may then be provided from the telematics system 14 to the vehicle network. The location-specific information is distributed to the various vehicles within the vehicle network.

Various types of uses for the present invention will be evident to those skilled in the art. For example, incident reporting, accident avoidance/mitigation, vehicle-to-vehicle adaptive cruise control functions, intersection communication, navigational information and digital coupons may be incorporated in such systems. For incident reporting, road hazards, accidents, construction, road conditions (black ice) may be communicated along large networks so that the need for traditional telematics may be replaced with more peer-to-peer communication.

The vehicle communication protocol may be a wide local area network, Bluetooth network, or various other types of wireless networks.

As can be seen, efficiencies of the telematics system is increased because the information need only be provided to one vehicle within the network. The information is then distributed to all the vehicles in the network. Thus, the efficiencies are increased by at least a factor of the size of the vehicle network.

While particular embodiments of the invention have been shown and described, numerous variations and alternate embodiments will occur to those skilled in the art. Accordingly, it is intended that the invention be limited only in terms of the appended claims.

1. A vehicle within a vehicle network having a plurality of vehicles, said vehicle network receiving location specific information from a telematics provider comprising:
a positioning system generating a vehicle position signal;
a transmitter communicating the vehicle position signal to the plurality of vehicles;
a receiver receiving the location specific information; and
a network controller maintaining a vehicle network connection in response to the vehicle position signal.

2. A vehicle as recited in claim 1 further comprising a display coupled to the network controller, said display displaying said location-specific information.

3. A vehicle as recited in claim 1 wherein said network controller is coupled to a vehicle controller.

4. A vehicle as recited in claim 3 wherein said vehicle controller is coupled to a safety system generating a safety system signal, said transmitter transmitting said safety system signal.

5. A vehicle as recited in claim 3 wherein said vehicle controller is coupled to a security system generating a security system signal, said transmitter transmitting said security system signal.

6. A vehicle as recited in claim 3 wherein said vehicle controller is coupled to vehicle sensors generating vehicle sensor signals, said transmitter transmitting said vehicle sensor signals.

7. A vehicle as recited in claim 1 wherein said positioning system comprises a global positioning system.

8. A communication system comprising:
a plurality of vehicles in communication forming a wireless vehicle network therebetween;
a communication network;
a telematics system coupled to the vehicle network through the communication network, said telematics system generating location specific information and coupling the in location-specific information to said wireless vehicle network through said network, so that said vehicle information is provided said plurality of vehicles.

9. A communication system as recited in claim 8 wherein each vehicle comprises a display coupled to each of the plurality of vehicles, said display displaying said location-specific information.

10. A communication system as recited in claim 8 wherein said wireless vehicle network comprises a floating vehicle network.

11. A communication system as recited in claim 8 wherein said wireless vehicle network comprises a Bluetooth network or a wide local area network.

12. A communication system as recited in claim 8 wherein each of said plurality of vehicles comprises:
a positioning system generating a vehicle position signal;
a transmitter communicating the vehicle position signal to the plurality of vehicles;
a receiver receiving the location specific information;
a controller maintaining a vehicle network connection in response to the vehicle position signal.

13. A communication system as recited in claim 12 further comprising a display coupled to the controller, said display displaying said location-specific information.

14. A vehicle as recited in claim 12 wherein said vehicle controller is coupled to a safety system generating a safety system signal, said transmitter transmitting said safety system signal.

15. A vehicle as recited in claim 12 wherein said vehicle controller is coupled to a security system generating a security system signal, said transmitter transmitting said security system signal.

16. A vehicle as recited in claim 12 wherein said vehicle controller is coupled to vehicle sensors generating vehicle sensor signals, said transmitter transmitting said vehicle sensor signals.

17. A method of operating a communication network comprising:
generating communication signals among a plurality of vehicles to form a wireless network therebetween;
communicating location information from the wireless network to a telematics provider;
transmitting location-specific information from the telematics provide to said wireless network; and
distributing the location specific information among the plurality of vehicles.

18. A method as recited in claim 17 wherein at least one of said plurality of vehicles generates a safety system signal and transmits said safety system signal to the telematics system.

19. A method as recited in claim 17 wherein at least one of said plurality of vehicles generates a security system signal and transmits said security system signal to the telematics system.

20. A method as recited in claim 17 wherein at least one of said plurality of vehicles generates a sensor signal and transmits said sensor signal to the telematics system.
